(19) United States
(12) Patent Application Publication
(10) Pub. No.: US 2005/0020743 A1
(43) Pub. Date: Jan. 27, 2005

(54) Buffer-effect dispersants for paint bases and compositions

(76) Inventors: Denis Ruhlmann, Genay (FR); Jean-Marc Suau, Lucenay (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/489,758

(22) PCT Filed: Sep. 12, 2002
(86) PCT No.: PCT/FR02/03101

(30) Foreign Application Priority Data
Sep. 18, 2001 (FR) 01/12048

(51) Int. Cl. C08L 1/00

(52) U.S. Cl. 524/284; 524/556

(57) ABSTRACT

The invention concerns the use, as a buffer dispersing agent for compositions and bases for water-based paints and pigmentary compositions in aqueous phase similar to paints, of the combination of a partially or totally neutralised water-soluble dispersing agent which is a homopolymer of acrylic or methacrylic acid with at least one other unsaturated ethylenic monomer, alone or in mixture, with a compound having specific buffer properties. It also concerns buffer dispersing agents and the compositions and bases for water-based paints and pigmentary compositions in aqueous phase similar to the paints containing them.

The present invention relates to the technical sector of pigmentary compositions, and in particular pigmentary compositions for aqueous paints and analogous compositions in aqueous phase, and even more precisely pigmentary bases for paint and more particularly the field of dispersants adapted to such bases and compositions.

In the technical field in question, numerous dispersants are known, such as polyacrylates, that are added to an aqueous medium or to water, and that develop a very limited buffer effect.

It is known that pH increases significantly as of low concentrations of about 1 gram per liter (g/l) of totally neutralized acrylic dispersant, peaks at about 9.5 to 10, and then decreases progressively when the concentration increases, to stabilize at a pH of about 8 for a concentration of about 400 g/l.

In most industrial applications, that inherent characteristic does not pose any serious problems.

However, a serious problem does arise when such dispersant agents are used in aqueous paints and in pigmentary compositions in aqueous phase. The dispersant, which is thus generally a polymer of the acrylic type, such as a polyacrylate, is then “highly diluted”. Its usual concentration of dry substance relative to water lies in the range 2 g/l to 4 g/l.

Unfortunately, it is well known that paints are constituted in particular of latex (ester-type polymers in particular) which can undergo hydrolysis if the pH reaches a value of about9.5 to 10.

A problem that is very specific to bases and to compositions for aqueous paints and analogous compositions in aqueous phase based on latex containing esters does arise when dispersants of the above-mentioned type are used.

In addition, bases or compositions for paints contain fillers, such as calcium carbonate, kaolin, TiO₂ and the like that are well known and that have pH close to neutral (pH about 7), and the “highly diluted” dispersant finds it difficult to adsorb correctly at the surface of those particles, whereas that is one of its main mechanisms for action.

That can be expressed overall by two major consequences that have always posed problems to the end user, namely firstly the problem of a shift in viscosity (often an increase in viscosity) over time of the base or composition during storage, and secondly the problem of a decrease in the resistance of the dry film to wet abrasion, or “resistance to water”.

Patent DE 197 43 841 (BK) relates to the same problem as the problem solved by the present invention, but it provides a solution that, as shown below, is totally different from the solution provided by the invention. That document proposes a copolymer of maleic anhydride with diisobutylene associated at the time of formulation with polyphosphate, which is totally different from what is proposed below.

Patent FR 2 765 495 (Synthron) describes a dispersant agent that is essentially used for the sector of paper manufacturing, and that is formed by a cationic polymer as a dispersant and of an organophosphorus molecule. In that document, the object is to increase the effectiveness of the dispersant. The problem addressed is thus not the problem addressed by the invention. In addition, problems related to increase in pH are not encountered in pulps and compositions for manufacturing paper.

Furthermore, the invention does not use cationic polymers.

The following scientific publications are also known:

“Methods in enzymology”, 1982, vol. 87, pages 405 et seq. describes the general characteristics relating to buffers and their domains of effectiveness.

“Colourage” (Kamat and Borkar), January 1993, pages 19 et seq. indicates that, in the field of textiles, dye baths must be of pH that is strictly controlled, in order to improve hooking of the dyes onto the fabrics. Several buffers are studied in that publication, in order to select the one(s) that lead to better reactivity of the dye on the textile.

“Paint & Ink International”, May/June 1997, pages 18 et seq. describes the use of products used in the above-mentioned BK™ German patent DE 197 43 841. The dispersant is a polyacrylate which, during formulation, is associated with a substance Calgon™ of the hexametaphosphate type which acts as a co-dispersant improving resistance to wet abrasion. It is thus a mixture of two dispersants. That also confirms the above analysis of Patent DE 197 43 841.

To sum up on the prior art, naturally a large number of buffers are known that are used in large numbers of industries but use has never been described or suggested of dispersants that are pre-combined in any way whatsoever with a compound having specific buffer properties for solving the above-mentioned specific problems related to application in the field of aqueous paints and analogous compositions in aqueous phase.

A compound having specific buffer properties is defined as being any organic or inorganic compound which, when inserted into the continuous aqueous phase of the composition, and as of low concentrations relative to water, namely concentrations relative to water of about 10 ppm, has the property of stabilizing the pH of said phase.

In particular, no document of the prior art has raised the problem of high dilution of a dispersant of the polyacrylate type. There thus exists a major and recognized need for improving the behavior of a dispersant in a continuous phase when said dispersant is highly diluted.

An object of the invention is thus to propose white bases and/or aqueous pigmentary compositions for paint (referred to below including the claims as “compositions” for simplicity reason), containing at least one buffer-effect dispersant or a dispersant/buffer system (referred to below as “buffer dispersant”, for simplicity reasons).

The invention also relates to such buffer dispersants, the specific choice of which and the inserted quantity of which make it possible to adjust as well as possible and as accurately as possible the pH of the medium for the application in question.

As is known by the person skilled in the art, white bases contain fillers such as carbonates, in particular calcium, titanium oxide TiO₂, kaolin, and analogous fillers that are well known and that can be used in the invention.

The present invention thus relates to buffer dispersants for compositions and bases for aqueous paints and pigmentary compositions in aqueous phase that are analogous to paints (referred to below as “paints”), characterized in that they consist of or include a water-soluble dispersant that is partially or totally neutralized and that is a homopolymer of acrylic or methacrylic acid or a copolymer of acrylic or methacrylic acid with at least one other unsaturated ethylenic monomer, on its own or in mixture, which water-soluble dispersant is combined with a compound having specific buffer properties.

Said other unsaturated ethylenic monomer is selected from itaconic acid, crotonic acid, fumaric acid, maleic anhydride and/or 2-acrylamido-2-methyl-1-propane sulfonic acid in acid or partially neutralized form, allylsulfonic acid, methallylsulfonic acid, allyloxybenzene sulfonic acid, methallyloxybenzene sulfonic acid, 2-hydroxy-3-(2-propenyloxy)propane sulfonic acid, 2-methyl-2-propene-1-sulfonic acid, ethylene sulfonic acid, propene sulfonic acid, 2-methyl sulfonic acid, styrene sulfonic acid and/or salts thereof, vinyl sulfonic acid, sodium methallylsulfonate, sulfopropyl acrylate or methacrylate, sulfomethylacrylamide, sulfomethylmethacrylamide, or else from acrylamide, methylacrylamide, esters of acrylic or methacrylic acids such as in particular ethyl acrylate, butyl acrylate, methyl methacrylate, phosphate of ethylene or propylene glycol acrylate or methacrylate, or else from vinylpyrrolidone, vinylcaprolactame, isobutylene, diisobutylene, vinyl acetate, styrene, alphamethylstyrene, vinylmethylether, and allylics such as allylamine and derivatives thereof.

More particularly, the buffer dispersants according to the invention, for compositions and bases for aqueous paints and pigmentary compositions in aqueous phase analogous to paints, are characterized in that the compound having specific buffer properties is an organic or inorganic compound which, when inserted in the continuous aqueous phase of the composition, both as of low concentrations relative to water, namely concentrations relative to water of about 10 ppm, and also at concentrations of as high as 50% by dry weight, has the property of stabilizing the pH of said phase.

In a preferred implementation, said compound having specific buffer properties is chosen so to adjust as well as possible and as accurately as possible the pH of the medium for the application in question.

In more particular manner, buffer dispersants according to the invention are characterized in that the compound having specific buffer properties is a salt or an acid selected for its buffer properties.

In a preferred implementation, said compound having specific buffer properties is selected from optionally neutralized weak acids of pKa<9.

In yet another preferred implementation, said compound having specific buffer characteristics is selected from succinic acid (pKa=5.28), citric acid (pKa=5.80), 3,3 dimethylglutaric acid (pKa=6.01), N-(2-acetamido)imino-diacetic acid (pKa=6.62), phosphoric acid (pKa=6.84), N,N-bis(2-hydroxyethyl)-2-amino ethane sulfonic acid also referred to as “BES” (pKa=6.98), 3-(N-bis(hydroxymethyl) methylamino)-2 hydroxypropane sulfonic acid also referred to as “DIPSO” (pKa=7.42), 3-(N-(trishydroxymethyl) methylamino)-2 hydroxypropane sulfonic acid also referred to as “TAPSO” (pKa=7.49), and N tris(hydroxymethyl)methyl glycine acid (pKa=7.92), and from their corresponding salts.

The products and the values are described in above-mentioned publication “Methods in Enzymology”, page 413.

In a preferred implementation, the counter-ion of the homopolymer or copolymer dispersant is selected from sodium, potassium, ammonium or an amine, magnesium or calcium.

Said counter-ion is preferably sodium, potassium, or ammonium.

In the prior art, it is known that dispersants of the polyacrylate type are effective as dispersants when they are in the dissociated state.

To that end, they must therefore be neutralized. That involves use of an alkali for bringing the neutralization pH to a value lying in the range approximately 7 to approximately 10.

At such a pH, polyacrylate dispersants are indeed well dissociated.

It has however been demonstrated and is well known that they are less chemisorbable, i.e. they do not react or interact favorably with the surfaces of the inorganic particles.

In that state, if high dilution of the dispersant in a composition for paint is effected, the problem, about which industry was not concerned or had not really identified the reason and which is solved by the invention, inevitably arises.

It is surprising, under such conditions, to note that the invention recommends adding a compound having specific buffer properties in combination with a dispersant of the polyacrylate type that is a homopolymer or a copolymer, as described above.

The person skilled in the art can understand that such addition goes against the desired dissociation.

The invention is all the more surprising since it is well known that a water-soluble salt has a poison effect in a dispersant formulation. It is also known that a salt is a very poor dispersant.

It should also be noted that the dispersant effect is a function of the polydispersity of the water-soluble dispersant polymer, and that it can, in particular, be improved by reducing its polydispersity.

The invention also relates to the use of the combination, in accordance with the invention, of a compound having specific buffer properties and of a water-soluble dispersant that is partially or totally neutralized and that is a homopolymer of acrylic or methacrylic acid or a copolymer of acrylic or methacrylic acid with at least one other unsaturated ethylenic monomer, on its own or in mixture, as a buffer dispersant for compositions and bases for aqueous paints and pigmentary compositions in aqueous phase analogous to paints.

The use in accordance with the invention as a buffer dispersant for compositions and bases for aqueous paints and pigmentary compositions in aqueous phase analogous to paints, of the combination of a compound having specific buffer properties and of a water-soluble dispersant that is partially or totally neutralized and that is a homopolymer of acrylic or methacrylic acid or a copolymer of acrylic or methacrylic acid with at least one other unsaturated ethylenic monomer, or else a mixture of homopolymer of acrylic or methacrylic acid with an above-mentioned copolymer, is characterized in that the compound having specific buffer properties is an organic or inorganic compound which, when inserted in the continuous aqueous phase of the composition, both as of low concentrations relative to water, namely concentrations relative to water of about 10 ppm, and also at concentrations of as high as 50% by dry weight, has the property of stabilizing the pH of said phase.

The invention finally relates to aqueous compositions (pigmentary compositions and/or white bases), characterized in that they contain the buffer dispersant compound according to the invention and more particularly 0.05% by dry weight to 2% by dry weight, and very particularly 0.10% by dry weight to 0.15% by dry weight of said buffer dispersant compound.

Other characteristics and advantages of the invention will be better understood on reading the following description, and the non-limiting examples below.

### EXAMPLE 1

The purpose of this example is to show the rheological properties of the samples stored at ambient temperature, and the properties of resistance to wet abrasion imparted by the buffer dispersant agents according to the invention for paint formulations that are matt, without solvent, and with constant quantities.

For all of the tests of the example, the water-soluble dispersant is a homopolymer of acrylic acid.

These paint formulations contain the ingredients and additives listed in the first portion of Table 1 and which are components of the white base and which will be recognized by the skilled man in the art.

In said first portion of the Table 1:
Natrosol™ 250 HBR is a cellulose thickener sold by Aqualon.
Coatex™ P50 is a dispersant of the polyacrylate type sold by Coatex.
Tego Foamex™ 1488 is an anti-foaming agent sold by Tego Chimie.
Mergal K6N™ is a biocide agent sold by Troy.
TiO₂ RHD2 is a titanium oxide sold by Elementis.
Omyacarb™ 5 is a known fine filler of the natural CaCO₃ type, sold by Omya.
Socal™ P3 is a known filler, of the synthetic CaCO₃ type, also known as “precipitated calcium carbonate”, sold by Solvay.
Mowilith™ LDM 1871 is a binder of the ethylene-vinyl-acetate type sold by Clariant.
Acrysol™ RM8W is a thickener of the polyurethane type sold by Rohm & Haas.

For each test, the above-mentioned matt paint formulation was prepared, and the buffer dispersant agent to be tested was added to the formulation.

Then, for each of the tests, the rheological properties and the resistance to wet-abrasion of the resulting formulation are measured.

For the rheological properties, ICI viscosity (known by the skilled man in the art) is measured. That measurement is the “cone/plane” measurement that represents or makes it possible to appraise the viscosity of the formulation when applied to a medium.

When shear is applied, i.e. in particular on application, an ICI viscosity that increases indicates that, in a single pass, a coat of paint of larger thickness is applied.

The Brookfield™ viscosity is also measured, that viscosity measurement giving an indication of the viscosity at low shear, and thus of the storage or “in-pot” properties, in particular in-pot stability.

At T=0, it is the immediate viscosity, at T=24 h the viscosity is considered to be sufficiently stabilized and up to one month (T=1 month), the storage or “in-pot” stability is assessed by comparing the Brookfield™ viscosities obtained after one month with the Brookfield™ viscosities obtained after 24 hours.

The resistance to wet abrasion (“WA”) or “water resistance” is also measured in compliance with Standard DIN 53 778, which represents a wear test on a film of paint applied to a medium. The film is standardized at 100 microns of thickness in the dry state, and the test is conducted by means of a calibrated brush. The number of brush cycles necessary to reach a standardized wear level is measured.

All of the results are given in Table 1 below in which the abbreviations have the following meanings:
TAPSO: 3-(N-(trishydroxymethyl) methylamino)-2 hydroxypropane sulfonic acid
DIPSO: 3-(N-bis(hydroxyethyl) methylamino)-2 hydroxypropane sulfonic acid
BES: N,N-bis(2-hydroxyethyl)-2 aminoethane sulfonic acid
Coatex™ P50: reference prior art, polyacrylate dispersant sold by Coatex.

Water is added as shown in the first portion of the Table, and an additional quantity of water is added for adjustment purposes as shown in the lower portion of the Table.

Test No. 1:

This test illustrates the prior art and implements 0.12% by dry weight of the sodium polyacrylate sold by Coatex under the name Coatex™ P50.

Test No. 2:

This test illustrates the invention and implements 0.12% by dry weight of buffer dispersant according to the invention constituted by 30% by dry weight of phosphoric acid and by 70% by dry weight of the sodium polyacrylate sold by Coatex under the name Coatex™ P50.

Test No. 3:

This test illustrates the invention and implements 0.12% by dry weight of the buffer dispersant according to the invention constituted by 0.5% by dry weight of TAPSO and by 99.5% by dry weight of the sodium polyacrylate sold by Coatex under the name Coatex™ P50.

Test No. 4:

This test illustrates the invention and implements 0.12% by dry weight of the buffer dispersant according to the invention constituted by 2.4% by dry weight of TAPSO and by 97.6% by dry weight of the sodium polyacrylate sold by Coatex under the name Coatex™ P50.

Test No. 5:

This test illustrates the invention and implements 0.12% by dry weight of the buffer dispersant according to the invention constituted by 0.5% by dry weight of DIPSO and by 99.5% by dry weight of the sodium polyacrylate sold by Coatex under the name Coatex™ P50.

Test No. 6:

This test illustrates the invention and implements 0.12% by dry weight of the buffer dispersant according to the invention constituted by 2.4% by dry weight of DIPSO and by 97.6% by dry weight of the sodium polyacrylate sold by Coatex under the name Coatex™ P50.

Test No. 7:

This test illustrates the invention and implements 0.12% by dry weight of the buffer dispersant according to the invention constituted by 0.5% by dry weight of citric acid and by 99.5% by dry weight of the sodium polyacrylate sold by Coatex under the name Coatex™ P50.

Test No. 8:

This test illustrates the invention and implements 0.12% by dry weight of the buffer dispersant according to the invention constituted by 2.4% by dry weight of citric acid and by 97.6% by dry weight of the sodium polyacrylate sold by Coatex under the name Coatex™ P50.

Test No. 9:

This test illustrates the invention and implements 0.12% by dry weight of the buffer dispersant according to the invention constituted by 0.5% by dry weight of BES and by 99.5% by dry weight of the sodium polyacrylate sold by Coatex under the name Coatex™ P50.

Test No. 10:

This test illustrates the invention and implements 0.12% by dry weight of buffer dispersant according to the invention constituted by 2.4% by dry weight of BES and by 97.6% by dry weight of sodium polyacrylate sold by Coatex under the name Coatex™ P50.

TABLE 1

| | | Prior art | Invention | Invention | Invention | Invention | Invention | Invention | Invention | Invention | Invention |
|---|---|---|---|---|---|---|---|---|---|---|---|
| | | Test No. | | | | | | | | | |
| | | 1 | 2 | 3 | 4 | 5 | 6 | 7 | 8 | 9 | 10 |
| Water (in g) | | 300 | 300 | 300 | 300 | 300 | 300 | 300 | 300 | 300 | 300 |
| NaOH (in g) | | 0.1 | 0.1 | 0.1 | 0.1 | 0.1 | 0.1 | 0.1 | 0.1 | 0.1 | 0.1 |
| Natrosol 250 HBR (in g) | | 1.5 | 1.5 | 1.5 | 1.5 | 1.5 | 1.5 | 1.5 | 1.5 | 1.5 | 1.5 |
| P50 (in g) | | 3 | \ | \ | \ | \ | \ | \ | \ | \ | \ |
| P50 + Phosphoric acid | | \ | 3 | \ | \ | \ | \ | \ | \ | \ | \ |
| (70-30) (in g) | | | | | | | | | | | |
| P50 + Tapso (99.5-0.5) (in g) | | \ | \ | 3 | \ | \ | \ | \ | \ | \ | \ |
| P50 + Tapso (97.6-2.4) (in g) | | \ | \ | \ | 3 | \ | \ | \ | \ | \ | \ |
| P50 + Dipso (99.5-0.5) (in g) | | \ | \ | \ | \ | 3 | \ | \ | \ | \ | \ |
| P50 + Dipso (97.6-2.4) (in g) | | \ | \ | \ | \ | \ | 3 | \ | \ | \ | \ |
| P50 + Citric acid (99.5-0.5) | | \ | \ | \ | \ | \ | \ | 3 | \ | \ | \ |
| (in g) | | | | | | | | | | | |
| P50 + Citric acid (97.6-2.4) | | \ | \ | \ | \ | \ | \ | \ | 3 | \ | \ |
| (in g) | | | | | | | | | | | |
| P50 + BES (99.5-0.5) (in g) | | \ | \ | \ | \ | \ | \ | \ | \ | 3 | \ |
| P50 + BES (97.6-2.4) (in g) | | \ | \ | \ | \ | \ | \ | \ | \ | \ | 3 |
| Mergal K6N (in g) | | 2 | 2 | 2 | 2 | 2 | 2 | 2 | 2 | 2 | 2 |
| Tego Foamex 1488 (in g) | | 2 | 2 | 2 | 2 | 2 | 2 | 2 | 2 | 2 | 2 |
| TiO2 RHD2 (in g) | | 70 | 70 | 70 | 70 | 70 | 70 | 70 | 70 | 70 | 70 |
| Socal P3 (in g) | | 200 | 200 | 200 | 200 | 200 | 200 | 200 | 200 | 200 | 200 |
| Omyacarb 5 (in g) | | 310 | 310 | 310 | 310 | 310 | 310 | 310 | 310 | 310 | 310 |
| NaOH (in g) | | 0.5 | 1 | 0.5 | 0.5 | 0.5 | 0.5 | 0.5 | 0.5 | 0.5 | 0.5 |
| Mowilith LDM 1871 (in g) | | 70 | 70 | 70 | 70 | 70 | 70 | 70 | 70 | 70 | 70 |
| Water (in g) | | 25.9 | 25.4 | 25.9 | 25.9 | 25.9 | 25.9 | 25.9 | 25.9 | 25.9 | 25.9 |
| Acrysol RM8W (in g) | | 15 | 15 | 15 | 15 | 15 | 15 | 15 | 15 | 15 | 15 |
| Total (g) | | 1000 | 1000 | 1000 | 1000 | 1000 | 1000 | 1000 | 1000 | 1000 | 1000 |
| % Dispersing agent | | 0.12 | 0.12 | 0.12 | 0.12 | 0.12 | 0.12 | 0.12 | 0.12 | 0.12 | 0.12 |
| T = 0 | ICI | 1.2 | 1.2 | 1.1 | 1.1 | 1.1 | 1.2 | 1.2 | 1.2 | 1.1 | 1.2 |
| | 10 rpm | 7000 | 8100 | 7700 | 7000 | 6700 | 8000 | 7200 | 7200 | 6500 | 7000 |
| | 100 rpm | 1450 | 1550 | 1550 | 1450 | 1450 | 1550 | 1550 | 1550 | 1450 | 1500 |
| T = 24 hr | ICI | 1.1 | 1 | 1.1 | 1.1 | 1 | 1.1 | 1.1 | 1.1 | 1.1 | 1.1 |
| | 10 rpm | 10300 | 10500 | 12200 | 10800 | 10300 | 10700 | 10400 | 10100 | 10200 | 10900 |
| | 100 rpm | 1950 | 2000 | 2100 | 2000 | 2000 | 2050 | 1950 | 2100 | 2000 | 2050 |
| T = 1 month | ICI | 1 | 0.9 | 0.9 | 0.9 | 0.9 | 0.9 | 0.9 | 0.9 | 1 | 1 |
| (25° C.) | 10 rpm | 22000 | 15200 | 21500 | 21600 | 21500 | 21200 | 20000 | 20800 | 21300 | 21500 |
| | 100 rpm | 3250 | 2600 | 3400 | 3200 | 3200 | 3300 | 3200 | 3150 | 3250 | 3250 |

| | | | | | | | | | | |
|---|---|---|---|---|---|---|---|---|---|---|
| WA (28 days at ambient | 390 | 460 | 400 | 420 | 450 | 420 | 430 | 450 | 430 | 470 |
| temp.) | | | | | | | | | | |

The reading of table 1 makes it possible to see that the use of buffer dispersants according to the invention gives simultaneously rheological properties and resistance to wet abrasion that are better than those obtained by implementing a prior art dispersant.

In addition, it is possible to observe that the compound obtained with BES is very effective.

### EXAMPLE 2

The purpose of this example is to show the rheological properties of the samples stored at a temperature equal to 50° C., representative of storage for 6 months at 25° C., and the properties of resistance to wet abrasion imparted by the buffer dispersant agents according to the invention for paint formulations that are matt, without solvent, and with constant quantities.

These paint formulations contain the ingredients and additives listed in the first portion of Table 2 and which are components of the white base and which will be recognized by the skilled man in the art.

For each test, the above-mentioned matt paint formulation was prepared, and the buffer dispersant agent to be tested was added to the formulation.

Then, for each of the tests, the Theological properties and the resistance to wet abrasion of the resulting formulation are measured.

For the rheological properties, ICI viscosity (known by the skilled man in the art) is measured using the same method and the same instruments and apparatus as those described in example 1.

The Brookfield™ viscosity is also measured, after one month of ageing accelerated by a temperature effect.

Thus, the sample is kept at 50° C. for one month, then it is reduced to 25° C. just before the measurement. Once month at 50° C. represents substantially 6 months of storage at 25° C.

The resistance to wet abrasion (“WA”) or “water resistance” is also measured in compliance with Standard DIN 53 778, with the same method and the same instruments and apparatus as those described in example 1.

All of the results are given in Table 2 below, in which the abbreviations have the same meanings as in Table 1.

Test No. 11

This test illustrates the prior art and implements 0.12% by dry weight of the sodium polyacrylate sold by Coatex under the name Coatex™ P50.

Test No. 12:

This test illustrates the invention and implements 0.12% by dry weight of buffer dispersant according to the invention constituted by 0.5% by dry weight of phosphoric acid and by 99.5% by dry weight of the sodium polyacrylate sold by Coatex under the name Coatex™ P50.

Test No. 13:

This test illustrates the invention and implements 0.12% by dry weight of buffer dispersant according to the invention constituted by 0.5% by dry weight of TAPSO and by 99.5% by dry weight of the sodium polyacrylate sold by Coatex under the name Coatex™ P50.

Test No. 14:

This test illustrates the invention and implements 0.12% by dry weight of buffer dispersant according to the invention, constituted by 0.5% by dry weight of citric acid and by 99.5% by dry weight of the sodium polyacrylate sold by Coatex under the name Coatex™ P50.

Test No. 15:

This test illustrates the invention and implements 0.12% by dry weight of buffer dispersant according to the invention constituted by 0.5% by dry weight of succinic acid and by 99.5% by dry weight of the sodium polyacrylate sold by Coatex under the name Coatex™ P50.

Test No. 16:

This test illustrates the invention and implements 0.12% by dry weight of buffer dispersant according to the invention constituted by 0.5% by dry weight of BES and by 99.5% by dry weight of the sodium polyacrylate sold by Coatex under the name Coatex™ P50.

TABLE 2

| | | Prior art | Invention | Invention | Invention | Invention | Invention |
|---|---|---|---|---|---|---|---|
| | | Test No. | | | | | |
| | | 11 | 12 | 13 | 14 | 15 | 16 |
| Water (in g) | | 300 | 300 | 300 | 300 | 300 | 300 |
| NaOH (in g) | | 0.1 | 0.1 | 0.1 | 0.1 | 0.1 | 0.1 |
| Natrosol 250 HBR (in g) | | 1.5 | 1.5 | 1.5 | 1.5 | 1.5 | 1.5 |
| P50 (in g) | | 3 | \ | \ | \ | \ | \ |
| P50 + Phosphoric acid (99.5-0.5) (in | | \ | 3 | \ | \ | \ | \ |
| g) | | | | | | | |
| P50 + Tapso (99.5-0.5) (in g) | | \ | \ | 3 | \ | \ | \ |
| P50 + Citric acid (99.5-0.5) (in g) | | \ | \ | \ | 3 | \ | \ |
| P50 + Succinic acid (99.5-0.5) (in g) | | \ | \ | \ | \ | 3 | \ |
| P50 + BES (99.5-0.5) (in g) | | \ | \ | \ | \ | \ | 3 |
| Mergal K6N (in g) | | 2 | 2 | 2 | 2 | 2 | 2 |
| Tego Foamex 1488 (in g) | | 2 | 2 | 2 | 2 | 2 | 2 |
| TiO2 RHD2 (in g) | | 70 | 70 | 70 | 70 | 70 | 70 |
| Socal P3 (in g) | | 200 | 200 | 200 | 200 | 200 | 200 |
| Omyacarb 5 (in g) | | 310 | 310 | 310 | 310 | 310 | 310 |
| NaOH (in g) | | 0.5 | 0.5 | 0.5 | 0.5 | 0.5 | 0.5 |
| Mowilith LDM 1871 (in g) | | 70 | 70 | 70 | 70 | 70 | 70 |
| Water (in g) | | 25.9 | 25.9 | 25.9 | 25.9 | 25.9 | 25.9 |
| Acrysol RM8W (in g) | | 15 | 15 | 15 | 15 | 15 | 15 |
| Total (g) | | 1000 | 1000 | 1000 | 1000 | 1000 | 1000 |
| % Dispersing agent | | 0.12 | 0.12 | 0.12 | 0.12 | 0.12 | 0.12 |
| T = 1 month | ICI | 1 | 0.8 | 0.9 | 0.9 | 0.9 | 0.9 |
| (50° C.) | 10 rpm | 33000 | 31000 | 27900 | 28900 | 27300 | 25000 |
| | 100 rpm | 4550 | 4300 | 4000 | 3950 | 3850 | 3800 |

| | | | | | | |
|---|---|---|---|---|---|---|
| WA (28 days at ambient temp.) | 380 | 430 | 480 | 450 | 400 | 400 |

The reading of table 2 makes it possible to see that the use of buffer dispersants according to the invention simultaneously gives rheological properties and resistance to wet abrasion that are better than those obtained by implementing a prior art dispersant.

### EXAMPLE 3

The purpose of this example is to show the rheological properties of the samples stored at ambient temperature, and the properties of resistance to wet abrasion imparted by the buffer dispersant agents according to the invention for paint formulations that are matt, without solvent, and with constant quantities; the water-soluble dispersant being a copolymer of acrylic acid.

These paint formulations contain the ingredients and additives listed in the first portion of Table 3 and which are components of the white base and which will be recognized by the skilled man in the art.

In said first portion of the Table 3:
Natrosol™ 250 HBR is a cellulose thickener sold by Aqualon.
Tego Foamex™ 1488 is an anti-foaming agent sold by Tego Chimie.
Mergal K6N™ is a biocide agent sold by Troy.
TiO₂ RHD2 is a titanium oxide sold by Elementis.
Omyacarb™ 5 is a known fine filler of the natural CaCO₃ type, sold by Omya.
Socal™ P3 is a known filler, of the synthetic CaCO₃ type, also known as “precipitated calcium carbonate”, sold by Solvay.
Mowilith™ LDM 1871 is a binder of the ethylene-vinyl-acetate type sold by Clariant.
Coapur™ 830W is a thickener sold by Coatex.

The results obtained for each of the following tests implement a material and methods similar to those used in Example 1.

Test No. 17:

This test illustrates the prior art and implements 0.12% by dry weight of a copolymer totally neutralized with potash, of molecular weight by weight equal to about 10,000 and constituted by 70% by weight of acrylic acid and by 30% by weight of butyl acrylate.

Test No. 18:

This test illustrates the invention and implements 0.12% by dry weight of the buffer dispersant according to the invention constituted by 16% by dry weight of phosphoric acid and by 84% by dry weight of the copolymer of test No. 17.

The results are given in Table 3 below.

TABLE 3

| | | PRIOR ART | INVENTION |
|---|---|---|---|
| | | TEST No. | |
| | | 17 | 18 |
| Water (in g) | | 300 | 300 |
| NaOH (in g) | | 0.1 | 0.1 |
| Natrosol 250 HBR (in g) | | 1.5 | 1.5 |
| Copolymer (AA - ABu 100% KOH) (in g) | | 3 | \ |
| Copolymer (AA - ABu 100% KOH) + | | \ | 3 |
| phosphoric acid (84-16) (in g) | | | |
| Mergal K6N (in g) | | 2 | 2 |
| Tego Foamex 1488 (in g) | | 2 | 2 |
| TiO2 RHD2 (in g) | | 70 | 70 |
| Socal P3 (in g) | | 200 | 200 |
| Omyacarb 5 (in g) | | 310 | 310 |
| NaOH (in g) | | 1 | 1 |
| Mowilith LDM 1871 (in g) | | 70 | 70 |
| Water (in g) | | 36.4 | 36.4 |
| Coapur 830 W (in g) | | 4 | 4 |
| Total (g) | | 1,000 | 1,000 |
| % Dispersing agent | | 0.12 | 0.12 |
| T = 0 | ICI | 1.3 | 1.2 |
| | 10 rpm | 13,500 | 18,300 |
| | 100 rpm | 2,500 | 3,050 |
| T = 24 hr | ICI | 1.2 | 1 |
| | 10 rpm | 17,000 | 18,300 |
| | 100 rpm | 2,900 | 3,100 |
| T = 1 month | ICI | 1 | 1.1 |
| (25° C.) | 10 rpm | 26,300 | 23,000 |
| | 100 rpm | 4,050 | 3,700 |

| | | |
|---|---|---|
| WA (28 days at ambient temp) | 280 | 400 |

AA = acrylic acid
ABu = butyl acrylate

The reading of table 3 makes it possible to see that the use of buffer dispersants according to the invention simultaneously gives Theological properties and resistance to wet abrasion that are better than those obtained by implementing a prior art dispersant.

### EXAMPLE 4

The purpose of this example is to show the rheological properties of the samples stored at ambient temperature and the properties of resistance to wet abrasion imparted by the buffer dispersant agents according to the invention for paint formulations that are matt, without solvent, and with constant quantities, the buffer dispersant agents according to the invention containing variable quantities of up to 50% by dry weight of phosphoric acid.

These paint formulations contain the ingredients and additives listed in the first portion of Table 4 and which are components of the white base and which will be recognized by the skilled man in the art.

In said first portion of Table 4:
Mergal K6N™ is a biocide agent sold by Troy.
Byk™ 34 is an anti-foaming agent sold by Byk.
TiO₂ Tiona RL 68 is a titanium oxide sold by Millenium.
Durcal™ 2 is a known fine filler of the natural CaCO₃ type, sold by Omya.
Hydrocarb™ is a known fine filler, of the natural CaCO₃ type, sold by Omya.
Rhodopas™ DS 910 is a latex sold by Rhodia.
V46 is a thickener sold by Coatex.

The results obtained for each of the following tests implement a material and methods similar to those used in Example 1.

Test No. 19:

This test illustrates the prior art and implements 0.12% by dry weight of a sodium polyacrylate that was totally neutralized, and that is of molecular weight by weight equal to about 6000.

Test No. 20:

This test illustrates the invention and implements 0.12% by dry weight of buffer dispersant according to the invention constituted by 10% by dry weight of phosphoric acid and by 90% by dry weight of the polyacrylate of Test No. 19.

Test No. 21:

This test illustrates the invention and implements 0.12% by dry weight of buffer dispersant according to the invention constituted by 20% by dry weight of phosphoric acid and by 80% by dry weight of the polyacrylate of Test No. 19.

Test No. 22:

This test illustrates the invention and implements 0.12% by dry weight of buffer dispersant according to the invention constituted by 40% by dry weight of phosphoric acid and by 60% by dry weight of the polyacrylate of Test No. 19.

Test No. 23:

This test illustrates the invention and implements 0.12% by dry weight of buffer dispersant according to the invention constituted by 50% by dry weight of phosphoric acid and by 50% by dry weight of the polyacrylate of Test No. 19.

The results obtained are given in Table 4 below.

TABLE 4

| | | PRIOR ART | INVENTION | INVENTION | INVENTION | INVENTION |
|---|---|---|---|---|---|---|
| | | TEST No. | | | | |
| | | 19 | 20 | 21 | 22 | 23 |
| Water (in g) | | 160 | 160 | 160 | 160 | 160 |
| Liquid ammonia (in g) | | 1.0 | 1.0 | 1.0 | 1.0 | 1.0 |
| Polyacrylate (in g) | | 3 | \ | \ | \ | \ |
| Polyacrylate + phosphoric acid (90-10) (in g) | | \ | 3 | \ | \ | \ |
| Polyacrylate + phosphoric acid (80-20) (in g) | | \ | \ | 3 | \ | \ |
| Polyacrylate + phosphoric acid (60-40) (in g) | | \ | \ | \ | 3 | \ |
| Polyacrylate + phosphoric acid (50-50) (in g) | | \ | \ | \ | \ | 3 |
| Mergal K6N (in g) | | 2 | 2 | 2 | 2 | 2 |
| Byk 34 | | 1 | 1 | 1 | 1 | 1 |
| Tiona RL 68 (in g) | | 41 | 41 | 41 | 41 | 41 |
| Durcal 2 (in g) | | 328 | 328 | 328 | 328 | 328 |
| Hydrocarb (in g) | | 215 | 215 | 215 | 215 | 215 |
| Water (in g) | | 132.1 | 131.8 | 131.6 | 131.4 | 131.2 |
| Rhodopas DS 910 (in g) | | 82 | 82 | 82 | 82 | 82 |
| MEG (in g) | | 10 | 10 | 10 | 10 | 10 |
| WS (in g) | | 10 | 10 | 10 | 10 | 10 |
| Liquid ammonia (in g) | | 1.3 | 1.6 | 1.8 | 2.0 | 2.2 |
| V46 (in g) | | 13.6 | 13.6 | 13.6 | 13.6 | 13.6 |
| Total (g) | | 1,000 | 1,000 | 1,000 | 1,000 | 1,000 |
| % Dispersing agent | | 0.12 | 0.12 | 0.12 | 0.12 | 0.12 |
| T = 0 | 10 rpm | 13,200 | 9,000 | 8,400 | 8,100 | 9,100 |
| | 100 rpm | 2,400 | 1,750 | 1,650 | 1,550 | 1,800 |
| T = 24 hr | ICI | 1.3 | 1.3 | 1.3 | 1.3 | 1.3 |
| | 10 rpm | 10,200 | 7,100 | 6,900 | 7,300 | 9,000 |
| | 100 rpm | 2,100 | 1,600 | 1,600 | 1,600 | 1,900 |
| T = 1 month | 10 rpm | 6,700 | 5,000 | 5,500 | 6,200 | 6,600 |
| (25° C.) | 100 rpm | 1,620 | 1,350 | 1,400 | 1,650 | 1,750 |

| | | | | | |
|---|---|---|---|---|---|
| WA (28 days at ambient temp.) | 300 | 330 | 510 | 720 | 700 |

MEG = monoethylene glycol
WS = White Spirit

The reading of table 4 makes it possible to see that the use of buffer dispersants according to the invention with various quantities of buffer-property compounds simultaneously gives Theological properties and resistance to wet abrasion that are better than those obtained by implementing a prior art dispersant.

The invention also covers all implementations and all applications that are directly accessible to the person skilled in the art on reading the present patent application, on the basis of his or her own knowledge, and possibly through simple routine tests.

1. The use, as a buffer dispersant for compositions and bases for aqueous paints and pigmentary compositions in aqueous phase analogous to paints, of the combination of a compound having specific buffer properties and of a water-soluble dispersant that is partially or totally neutralized and that is a homopolymer of acrylic or methacrylic acid or a copolymer of acrylic or methacrylic acid with at least one other unsaturated ethylenic monomer, or else a mixture of homopolymer of acrylic or methacrylic acid with an above-mentioned copolymer, said use being characterized in that the compound having specific buffer properties is an organic or inorganic compound which, when inserted in the continuous aqueous phase of the composition, both as of low concentrations relative to water, namely concentrations relative to water of about 10 ppm, and also at concentrations of as high as 50% by dry weight, has the property of stabilizing the pH of said phase.

2. The use, as a buffer dispersant for compositions and bases for aqueous paints and pigmentary compositions in aqueous phase analogous to paints, according to claim 1, wherein the compound having specific buffer properties is a salt or an acid selected for its buffer properties.

3. The use, as a buffer dispersant for compositions and bases for aqueous paints and pigmentary compositions in aqueous phase analogous to paints, according to claim 1, wherein the compound having specific buffer properties is selected from optionally neutralized weak acids of pKa<9.

4. The use, as a buffer dispersant for compositions and bases for aqueous paints and pigmentary compositions in aqueous phase analogous to paints, according to claim 1 wherein the compound having specific buffer characteristics is selected from succinic acid, citric acid, 3,3 dimethylglutaric acid, N-(2-acetamido)imino-diacetic acid, phosphoric acid, N,N-bis(2-hydroxyethyl)-2-amino ethane sulfonic acid also referred to as “BES”, 3-(N-bis(hydroxymethyl) methylamino)-2 hydroxypropane sulfonic acid also referred to as “DIPSO”, 3-(N-(trishydroxymethyl) methylamino)-2 hydroxypropane sulfonic acid also referred to as “TAPSO”, and N tris(hydroxymethyl)methyl glycine acid and from their corresponding salts.

5. The use, as a buffer dispersant for compositions and bases for aqueous paints and pigmentary compositions in aqueous phase analogous to paints, according to claim 1, wherein the water-soluble dispersant that is partially or totally neutralized is a homopolymer of acrylic or methacrylic acid.

6. The use, as a buffer dispersant for compositions and bases for aqueous paints and pigmentary compositions in aqueous phase analogous to paints, according to claim 1, wherein the water-soluble dispersant that is partially or totally neutralized is a copolymer of acrylic or methacrylic acid with at least one other unsaturated ethylenic monomer.

7. The use, as a buffer dispersant for compositions and bases for aqueous paints and pigmentary compositions in aqueous phase analogous to paints, according to claim 6, wherein the unsaturated ethylenic monomer is selected from itaconic acid, crotonic acid, fumaric acid, maleic anhydride and/or 2-acrylamido-2-methyl-1-propane sulfonic acid in acid or partially neutralized form, allylsulfonic acid, methallylsulfonic acid, allyloxybenzene sulfonic acid, methallyloxybenzene sulfonic acid, 2-hydroxy-3-(2-propenyloxy)propane sulfonic acid, 2-methyl-2-propene-1-sulfonic acid, ethylene sulfonic acid, propene sulfonic acid, 2-methyl sulfonic acid, styrene sulfonic acid and/or salts thereof, vinyl sulfonic acid, sodium methallylsulfonate, sulfopropyl acrylate or methacrylate, sulfomethylacrylamide, sulfomethylmethacrylamide, or else from acrylamide, methylacrylamide, esters of acrylic or methacrylic acids such as ethyl acrylate, butyl acrylate, methyl methacrylate, phosphate of ethylene or propylene glycol acrylate or methacrylate, or else from vinylpyrrolidone, vinylcaprolactame, isobutylene, diisobutylene, vinyl acetate, styrene, alphamethylstyrene, vinylmethylether, and allylics such as allylamine and derivatives thereof.

8. The use, as a buffer dispersant for compositions and bases for aqueous paints and pigmentary compositions in aqueous phase analogous to paints, according to claim 5, wherein the water-soluble dispersant that is partially or totally neutralized is a mixture of a homopolymer of acrylic or methacrylic acid with a copolymer of acrylic or methacrylic acid with at least one other unsaturated ethylenic monomer; wherein the unsaturated ethylenic monomer is selected from itaconic acid, crotonic acid, fumaric acid, maleic anhydride and/or 2-acrylamido-2-methyl-1-propane sulfonic acid in acid or partially neutralized form, allylsulfonic acid, methallylsulfonic acid, allyloxybenzene sulfonic acid, methallyloxybenzene sulfonic acid, 2-hydroxy-3-(2-propenyloxy)propane sulfonic acid, 2-methyl-2-propene-1-sulfonic acid, ethylene sulfonic acid, propene sulfonic acid, 2-methyl sulfonic acid, styrene sulfonic acid and/or salts thereof, vinyl sulfonic acid, sodium methallylsulfonate, sulfopropyl acrylate or methacrylate, sulfomethylacrylamide, sulfomethylmethacrylamide, or else from acrylamide, methylacrylamide, esters of acrylic or methacrylic acids such as ethyl acrylate, butyl acrylate, methyl methacrylate, phosphate of ethylene or propylene glycol acrylate or methacrylate, or else from vinylpyrrolidone, vinylcaprolactame, isobutylene, diisobutylene, vinyl acetate, styrene, alphamethylstyrene, vinylmethylether, and allylics such as allylamine and derivatives thereof.

9. The use, as a buffer dispersant for compositions and bases for aqueous paints and pigmentary compositions in aqueous phase analogous to paints, according to claim 1, wherein the counter-ion of the homopolymer or copolymer dispersant is selected from sodium, potassium, ammonium or an amine, magnesium or calcium, and is preferably selected from sodium, potassium, or ammonium.

10. A buffer dispersant for compositions and bases for aqueous paints and pigmentary compositions in aqueous phase analogous to paints, said buffer dispersant being characterized in that it consists of or includes a water-soluble dispersant that is partially or totally neutralized and that is a homopolymer of acrylic or methacrylic acid or a copolymer of acrylic or methacrylic acid with at least one other unsaturated ethylenic monomer, that is a homopolymer or a copolymer on its own or in mixture, which water-soluble dispersant is combined with a compound having specific buffer properties.

11. A buffer dispersant for compositions and bases for aqueous paints and pigmentary compositions in aqueous phase analogous to paints, according to claim 10, wherein the compound having specific buffer properties is an organic or inorganic compound which, when inserted in the continuous aqueous phase of the composition, both as of low concentrations relative to water, namely concentrations relative to water of about 10 ppm, and also at concentrations of as high as 50% by dry weight, has the property of stabilizing the pH of said phase.

12. A buffer dispersant for compositions and bases for aqueous paints and pigmentary compositions in aqueous phase analogous to paints, according to claim 10, wherein the compound having specific buffer properties is a salt or an acid selected for its buffer properties.

13. A buffer dispersant for compositions and bases for aqueous paints and pigmentary compositions in aqueous phase analogous to paints, according to claim 10, wherein the compound having specific buffer properties is selected from optionally neutralized weak acids of pKa<9.

14. A buffer dispersant for compositions and bases for aqueous paints and pigmentary compositions in aqueous phase analogous to paints, according to claim 10, wherein the compound having specific buffer characteristics is selected from succinic acid, citric acid, 3,3 dimethylglutaric acid, N-(2-acetamido)imino-diacetic acid, phosphoric acid, N,N-bis(2-hydroxyethyl)-2-amino ethane sulfonic acid also referred to as “BES”, 3-(N-bis(hydroxymethyl) methylamino)-2 hydroxypropane sulfonic acid also referred to as “DIPSO”, 3-(N-(trishydroxymethyl) methylamino)-2 hydroxypropane sulfonic acid also referred to as “TAPSO”, and N tris(hydroxymethyl)methyl glycine acid and from their corresponding salts.

15. A buffer dispersant for compositions and bases for aqueous paints and pigmentary compositions in aqueous phase analogous to paints, according to claim 10, wherein the water-soluble dispersant that is partially or totally neutralized is a homopolymer of acrylic or methacrylic acid.

16. A buffer dispersant for compositions and bases for aqueous paints and pigmentary compositions in aqueous phase analogous to paints, according to claim 10, wherein the water-soluble dispersant that is partially or totally neutralized is a copolymer of acrylic or methacrylic acid with at least one other unsaturated ethylenic monomer.

17. A buffer dispersant for compositions and bases for aqueous paints and pigmentary compositions in aqueous phase analogous to paints, according to claim 16, wherein the unsaturated ethylenic monomer is selected from itaconic acid, crotonic acid, fumaric acid, maleic anhydride and/or 2-acrylamido-2-methyl-1-propane sulfonic acid in acid or partially neutralized form, allylsulfonic acid, methallylsulfonic acid, allyloxybenzene sulfonic acid, methallyloxybenzene sulfonic acid, 2-hydroxy-3-(2-propenyloxy)propane sulfonic acid, 2-methyl-2-propene-1-sulfonic acid, ethylene sulfonic acid, propene sulfonic acid, 2-methyl sulfonic acid, styrene sulfonic acid and/or salts thereof, vinyl sulfonic acid, sodium methallylsulfonate, sulfopropyl acrylate or methacrylate, sulfomethylacrylamide, sulfomethylmethacrylamide, or else from acrylamide, methylacrylamide, esters of acrylic or methacrylic acids such as ethyl acrylate, butyl acrylate, methyl methacrylate, phosphate of ethylene or propylene glycol acrylate or methacrylate, or else from vinylpyrrolidone, vinylcaprolactame, isobutylene, diisobutylene, vinyl acetate, styrene, alphamethylstyrene, vinylmethylether, and allylics such as allylamine and derivatives thereof.

18. A buffer dispersant for compositions and bases for aqueous paints and pigmentary compositions in aqueous phase analogous to paints, according to claim 15. wherein the water-soluble dispersant that is partially or totally neutralized is a mixture of a homopolymer of acrylic or methacrylic acid with a copolymer of acrylic or methacrylic acid with at least one other unsaturated ethylenic monomer; wherein the unsaturated ethylenic monomer is selected from itaconic acid, crotonic acid, fumaric acid, maleic anhydride and/or 2-acrylamido-2-methyl-1-propane sulfonic acid in acid or partially neutralized form, allylsulfonic acid, methallylsulfonic acid, allyloxybenzene sulfonic acid, methallyloxybenzene sulfonic acid, 2-hydroxy-3-(2-propenyloxy)propane sulfonic acid, 2-methyl-2-propene-1-sulfonic acid, ethylene sulfonic acid, propene sulfonic acid, 2-methyl sulfonic acid, styrene sulfonic acid and/or salts thereof, vinyl sulfonic acid, sodium methallylsulfonate, sulfopropyl acrylate or methacrylate, sulfomethylacrylamide, sulfomethylmethacrylamide, or else from acrylamide, methylacrylamide, esters of acrylic or methacrylic acids such as ethyl acrylate, butyl acrylate, methyl methacrylate, phosphate of ethylene or propylene glycol acrylate or methacrylate, or else from vinylpyrrolidone, vinylcaprolactame, isobutylene, diisobutylene, vinyl acetate, styrene, alphamethylstyrene, vinylmethylether, and allylics such as allylamine and derivatives thereof.

19. A buffer dispersant for compositions and bases for aqueous paints and pigmentary compositions in aqueous phase analogous to paints, according to claim 10, wherein the counter-ion of the homopolymer or copolymer dispersant is selected from sodium, potassium, ammonium or an amine, magnesium or calcium, and is preferably selected from sodium, potassium, or ammonium .

20. A composition and a base for aqueous paints, and a pigmentary composition in aqueous phase analogous to paints, wherein it contains the buffer dispersant according to claim 10.

21. A composition and a base for aqueous paints and a pigmentary composition in aqueous phase analogous to paints according to claim 20, wherein it contains 0.05% by dry weight to 2% by dry weight of buffer dispersant.

22. A composition and a base for aqueous paints and a pigmentary composition in aqueous phase analogous to paints according to claim 20, wherein it contains 0.10% by dry weight to 0.15% by dry weight of buffer dispersant.
